(19) United States
(12) Patent Application Publication
(10) Pub. No.: US 2020/0059321 A1
(43) Pub. Date: Feb. 20, 2020

(54) COVERAGE ENHANCEMENT FOR OFDM TRANSMISSIONS

(71) Applicant: TELEFONAKTIEBOLAGET LM ERICSSON (PUBL), Stockholm (SE)

(72) Inventors: Havish KOORAPATY, Saratoga, CA (US); Jung-Fu CHENG, Fremont, CA (US); Amitav MUKHERJEE, Fremont, CA (US)

(21) Appl. No.: 16/349,702

(22) PCT Filed: Nov. 22, 2017
(86) PCT No.: PCT/IB2017/057349

§ 371 Date: May 14, 2019

Related U.S. Application Data
(60) Provisional application No. 62/426,139, filed on Nov. 23, 2016.

(51) Int. Cl. H04L 1/16; H04W 72/04; H04L 5/00; H04L 1/00; H04W 16/14

(52) U.S. Cl. CPC H04L 1/1671; H04W 72/0406; H04W 72/044; H04L 1/0028; H04W 16/14; H04L 5/001

(57) ABSTRACT

A radio access node is configured for use in a cellular communication network. The radio access node in this regard is adapted to improve transmission of cell reference symbols by formatting a slot of a subframe with a high density of cell reference symbols (CRS). The high density may be achieved by allocating CRSs over at least three different OFDM symbol index numbers of the slot. The radio access node is further adapted to transmit the high CRS density DL subframe to one or more wireless devices. Alternatively, or in addition, the radio access node is adapted to format an OFDM transmission scheme DL subframe as a coverage enhanced (CE) DL subframe by repeating a control channel at least once in the CE DL subframe. The radio access node is further configured to transmit the CE DL subframe to one or more wireless devices. A wireless device operable for use with the radio access node is also disclosed and has similar coverage enhancement capabilities.

### RELATED APPLICATIONS

This application claims the priority and benefit of U.S. Patent Application 62/426,139, filed Nov. 23, 2016, entitled “Coverage Enhancement for OFDM Transmissions in Unlicensed Spectrum”, which is incorporated herein by reference in its entirety.

### TECHNICAL FIELD

The disclosed subject matter relates generally to telecommunications and more particularly to enhancement of coverage for transmissions made using an OFDM transmission scheme.

### BACKGROUND

The Internet of Things (IoT) is a vision for the future world where everything that can benefit from a connection will be connected. Cellular technologies are being developed or evolved to play an indispensable role in the IoT world, particularly the machine type communication (MTC). While 3GPP MTC and IoT technologies are focused on narrowband systems with carrier bandwidths between 180 kHz and 5 MHz, certain applications such as video surveillance systems or other media-based use cases require wideband IoT systems, for example, 10 MHz or 20 MHz systems. For further ease of deployment and cost efficiency, such wideband IoT systems can be deployed in unlicensed spectrum, e.g., in the 2.4 GHz and 5 GHz bands. Existing LTE-based broadband systems in the unlicensed 5 GHz band include Licensed-Assisted Access (LAA) and MulteFire (MF), both of which support 10 MHz and 20 MHz system bandwidths. Unlike LAA, MF can be deployed solely in unlicensed spectrum without the need for licensed carriers and the first generation of MF is a candidate for deployment of wideband IoT systems having carriers of 10 MHz and 20 MHz.

Currently, widely used LTE-based radio technologies are generally adapted for operation in licensed spectrum. LTE uses an OFDMA transmission scheme in the downlink and DFT-spread OFDM (also referred to as single-carrier FDMA) in the uplink. For brevity, however, both the DL and the UL transmission schemes will be referred to herein as OFDM transmission schemes. The basic LTE downlink physical resource can thus be seen as a time-frequency grid as illustrated in FIG. 8, where each resource element corresponds to one OFDM subcarrier during one OFDM symbol interval. The uplink subframe has the same subcarrier spacing as the downlink and the same number of SC-FDMA symbols in the time domain as OFDM symbols in the downlink.

In the time domain, LTE downlink transmissions are organized into radio frames of 10 ms, each radio frame consisting of ten equally-sized subframes of length Tsubframe=1 ms as shown in FIG. 9. Each subframe comprises two slots of duration 0.5 ms each, and the slot numbering within a frame ranges from 0 to 19. For normal cyclic prefix, one subframe consists of 14 OFDM symbols. The duration of each symbol is approximately 71.4 μs.

Furthermore, the resource allocation in LTE is typically described in terms of resource blocks, where a resource block corresponds to one slot (0.5 ms) in the time domain and 12 contiguous subcarriers in the frequency domain. A pair of two adjacent resource blocks in time direction (1.0 ms) is known as a resource block pair. Resource blocks are numbered in the frequency domain, starting with 0 from one end of the system bandwidth.

Downlink transmissions are dynamically scheduled, i.e., in each subframe the base station transmits control information about which terminals data is transmitted to and upon which resource blocks the data is transmitted, in the current downlink subframe. This control signaling is typically transmitted in the first 1, 2, 3 or 4 OFDM symbols in each subframe and the number n=1, 2, 3 or 4 is known as the Control Format Indicator (CFI). The downlink subframe also contains common reference symbols, which are known to the receiver and used for coherent demodulation of e.g. the control information. A downlink system with CFI=3 OFDM symbols as control is illustrated in FIG. 10. The reference symbols shown in FIG. 10 are the cell-specific reference symbols (CRS), and are used to support multiple functions including fine time and frequency synchronization and channel estimation for certain transmission modes. Within a slot, the time-domain symbol location l of the CRS on antenna port p is given by

$$l = \{ \begin{matrix}0 , {N}_{symb}^{DL} - 3 & if p ∈ \{ 0 , 1 \} \\ 1 & if p ∈ \{ 2 , 3 \}\end{matrix}$$

where N_{symb}^{DL} is the number of OFDM symbols per DL slot.

Uplink transmissions are dynamically scheduled, i.e., in each downlink subframe the base station transmits control information about which terminals should transmit data to the eNB in subsequent subframes, and upon which resource blocks the data is transmitted. The uplink resource grid is comprised of data and uplink control information in the PUSCH, uplink control information in the PUCCH, and various reference signals such as demodulation reference signals (DMRS) and sounding reference signals (SRS). DMRS are used for coherent demodulation of PUSCH and PUCCH data, whereas SRS is not associated with any data or control information but is generally used to estimate the uplink channel quality for purposes of frequency-selective scheduling. An example uplink subframe is shown in FIG. 11. Note that UL DMRS and SRS are time-multiplexed into the UL subframe, and SRS are always transmitted in the last symbol of a normal UL subframe. The PUSCH DMRS is transmitted once every slot for subframes with normal cyclic prefix, and is located in the fourth and eleventh SC-FDMA symbols.

From LTE Rel-11 onwards, UE-specific DL or UL resource assignments can also be scheduled on the enhanced Physical Downlink Control Channel (EPDCCH), with possible aggregation level L∈{1,2,4,8,16,32}. For Rel-8 to Rel-10 only the Physical Downlink Control Channel (PDCCH) is available. Resource grants are UE specific and are indicated by scrambling the DCI Cyclic Redundancy Check (CRC) with the UE-specific C-RNTI identifier.

As noted above, MF is a LTE-based technology that operates solely in unlicensed and shared spectrum. The framing, numerology, uplink block-IFDMA structure, and channel access mechanism of MF is the same as that of LTE LAA. Compared to LAA, MF has additional support for transmission of master information block (MIB), system information blocks (SIB), and paging on the DL; unlike LAA, MF also supports the transmission of control information such as DL HARQ ACK and scheduling requests on the uplink (via sPUCCH and ePUCCH control channels), and random access preambles on the sPRACH. The DL HARQ feedback is an explicit bitmap, where the size of the bitmap is a function of the number of DL HARQ processes, MIMO configuration, and number of DL serving cells. MulteFire also features DL HARQ ACK feedback redundancy: within a TXOP, if there are multiple occasions for DL HARQ feedback indicated by the eNB, such as on both MF-sPUCCH and MF-ePUCCH and/or UCI on PUSCH, then the same HARQ feedback (bitmap) is sent on all such occasions.

Both MF and LAA must adhere to regulatory restrictions on the maximum channel occupancy time (MCOT) of any transmission burst in unlicensed bands. For 5 GHz, the MCOT limits are 6 ms, or 8 ms TXOP with a minimum pause of 100 μs after 6 ms on DL. Furthermore, a 10 ms TXOP is allowed if the DL LBT minimum contention window size is set to 31. Such restrictions result in insufficient coverage when using existing MF protocols for wideband IoT applications. In 3GPP MTC technologies, coverage enhancement is achieved via time-domain repetition of data and control transmissions. However, in unlicensed spectrum the availability of the channel is subject to contention and regulatory restrictions on the maximum channel occupancy, therefore time-domain repetitions cannot be arbitrarily long.

In a related publication, WO2016/092492, entitled “Preemptive Retransmissions on Listen-before-talk cells”, after performing listen-before-talk (LBT), a single PDCCH/EPDCCH resource grant is used to indicate the transmission of a PDSCH transport block with a certain redundancy version, and the immediate retransmission of that transport block with different redundancy versions in the next subframe(s). A similar preemptive retransmission policy is defined for the PUSCH on the uplink. This principle of preemptive retransmissions is, in effect, a way of enhancing DL and UL coverage on cells performing LBT in unlicensed spectrum. However, WO2016/092492 does not describe how to implement coverage enhancement for control information on LBT cells.

### SUMMARY

Some embodiments herein enhance the density of downlink reference signals on one or more ports of a downlink transmission of a cellular communications network. By increasing the RS density, the presence of a valid DL subframe can quickly be determined by wireless devices without having to buffer several subframes of received samples. Reducing the number of buffer samples needed for accurate subframe detection may in turn reduce wireless device implementation costs and power consumption. Moreover, some embodiments herein repeat control channel information within a single subframe of a DL or UL transmission. This technique provides enhanced coverage in comparison to the legacy solution of a control channel region that is repeated across different subframes because the control information may be detected by processing only a single subframe, as opposed to buffering and processing multiple subframes.

More particularly, embodiments herein include a method performed by a radio access node operable for use in a wireless communication system. The method includes formatting a slot of an OFDM transmission scheme DL subframe with a high density of cell reference symbols (CRS) by allocating CRSs over at least three different OFDM symbol index numbers of the slot. The method also includes transmitting the high CRS density DL subframe to one or more wireless devices. The high density allocation improves transmission of the CRS, among other things.

In some embodiments, the transmission is made over unlicensed spectrum. Furthermore, in some embodiments, the slot is formatted such that the time-domain locations of the CRSs for a single antenna slot reuse existing values defined or used for multiple antenna slots. Alternatively or additionally, in any of the above embodiments, the slot is further formatted to contain at least a portion of one of: a PDSCH, a PBCH, or a PDCCH.

In some embodiments, the method further includes multiplexing in time a DL subframe having low CRS density, in which cell reference symbols are allocated over less than three different OFDM symbol index numbers of a slot, with the high CRS density DL subframe. Furthermore, transmitting the high CRS density DL subframe includes transmitting the multiplexed subframes to the one or more wireless devices.

In some embodiments, the method further includes signaling to the one or more wireless devices, in advance of transmitting the high CRS density DL subframe, the presence of the high CRS density DL subframe.

Embodiments herein also include a method performed by a radio access node operable for use in a cellular communications network. The method comprises formatting an OFDM transmission scheme DL subframe as a coverage enhanced (CE) DL subframe by repeating a control channel at least once in the CE DL subframe. The method also comprises transmitting the CE DL subframe to one or more wireless devices. Embodiments herein also include a method performed by a wireless device configured to operate in a cellular communications network. The method includes formatting an OFDM transmission scheme UL subframe as a coverage enhanced (CE) UL subframe by repeating control information at least once in the CE UL subframe. The method also comprises transmitting the CE UL subframe to a radio access node. In some embodiments, the CE UL subframe is transmitted using unlicensed spectrum. Improved control channel coverage may be achieved by the repetition of the control channel in a single DL subframe. Similarly, improved control information transmission may be achieved by repetition of control information in a single UL subframe.

In some embodiments, the control channel includes a PDCCH. Additionally, in some embodiments the control channel further includes a repetition of at least one of a PHICH and a PCFICH multiplexed with the repeated PDCCH.

In some embodiments, the control channel includes an EPDCCH that is repeated at least once in the frequency domain.

In some embodiments, the DL subframe is formatted such that a first control channel region for a first instance of the control channel is offset from a subsequent control channel region for a second instance of the control channel by at least one OFDM symbol.

Embodiments herein correspondingly include a wireless device configured for use in a cellular communications network. The wireless device is adapted to format an OFDM transmission scheme UL subframe as a coverage enhanced (CE) UL subframe by repeating control information at least once in the CE UL subframe. The wireless device is also adapted to transmit the CE UL subframe to a radio access node.

Yet other embodiments herein include a radio access node configured for use in a cellular communications network. The radio access node is adapted to format a slot of an OFDM transmission scheme DL subframe with a high density of CRSs by allocating CRSs over at least three different OFDM symbol index numbers of the slot. The radio access node is further adapted to transmit the high CRS density DL subframe to one or more wireless devices.

Yet other embodiments herein include a radio access node adapted to format an OFDM transmission scheme DL subframe as a coverage enhanced (CE) DL subframe by repeating a control channel at least once in the CE DL subframe. The radio access node is further adapted to transmit the CE DL subframe to one or more wireless devices.

Embodiments herein also include corresponding systems, computer programs, carriers, and computer program products.

### BRIEF DESCRIPTION OF THE DRAWINGS

The drawings illustrate selected embodiments of the disclosed subject matter. In the drawings, like reference labels denote like features.

FIG. 1 is a diagram illustrating an LTE network.

FIG. 2 is a diagram illustrating a wireless communication device.

FIG. 3 is a diagram illustrating a radio access node.

FIG. 4 is a flowchart illustrating a method of operating a wireless communication device in accordance with embodiments of the present disclosure.

FIG. 5 is a diagram illustrating a wireless communication device in accordance with embodiments of the present disclosure.

FIG. 6A is a flowchart illustrating a method of operating a radio access node in accordance with embodiments of the present disclosure.

FIG. 6B is a flowchart illustrating another method of operating a radio access node in accordance with embodiments of the present disclosure.

FIG. 7 is a diagram illustrating a radio access node in accordance with embodiments of the present disclosure.

FIG. 8 is a schematic diagram of an example Orthogonal Frequency Division Multiplexing (OFDM) downlink physical resource.

FIG. 9 is a schematic diagram of an example OFDM time-domain structure.

FIG. 10 is a schematic diagram of an example OFDM downlink subframe.

FIG. 11 is a schematic diagram of an example OFDM uplink subframe.

FIG. 12 is a schematic diagram of a first example OFDM downlink subframe in accordance with embodiments of the present disclosure.

FIG. 13 is a schematic diagram of a second example OFDM downlink subframe in accordance with embodiments of the present disclosure.

FIG. 14 is a schematic diagram of a third example OFDM downlink subframe in accordance with embodiments of the present disclosure.

FIG. 15 is a schematic diagram of a fourth example OFDM downlink subframe in accordance with embodiments of the present disclosure.

### DETAILED DESCRIPTION

The following description presents various embodiments of the disclosed subject matter. These embodiments are presented as teaching examples and are not to be construed as limiting the scope of the disclosed subject matter. For example, certain details of the described embodiments may be modified, omitted, or expanded upon without departing from the scope of the described subject matter.

Radio Node: As used herein, a “radio node” is either a radio access node or a wireless device.

Radio Access Node: As used herein, a “radio access node” is any node in a radio access network of a cellular communications network that operates to wirelessly transmit and/or receive signals. Some examples of a radio access node include, but are not limited to, a base station (e.g., an enhanced or evolved Node B (eNB) in a Third Generation Partnership Project (3GPP) Long Term Evolution (LTE) network), a high-power or macro base station, a low-power base station (e.g., a micro base station, a pico base station, a home eNB, or the like), and a relay node.

Wireless Device: As used herein, a “wireless device” is any type of device that is capable of wirelessly transmitting and/or receiving signals to/from another wireless device or to/from a network node in a cellular communications network to obtain has access to (i.e., be served by) the cellular communications network. Some examples of a wireless device include, but are not limited to, a User Equipment device (UE) in a 3GPP network, a Machine Type Communication (MTC) device, an NB-IoT device, an FeMTC device, etc.

Network Node: As used herein, a “network node” is any node that is either part of the radio access network or the CN of a cellular communications network/system or a test equipment node.

Listen-Before-Talk (LBT): As used herein, “LBT” or an “LBT scheme” is any scheme in which a radio access node or wireless device monitors a channel in a frequency spectrum that requires LBT to determine whether the channel is clear (e.g., performs a Clear Channel Assessment (CCA)) before transmitting on the channel. The description herein focuses on an unlicensed frequency spectrum as the frequency spectrum that requires LBT; however, the frequency spectrum that requires LBT is not limited to an unlicensed frequency spectrum (e.g., the frequency spectrum that requires LBT may alternatively be a license shared frequency spectrum).

LBT Cell: As used herein, an “LBT cell” is a cell that operates on a channel in a frequency spectrum (e.g., an unlicensed frequency spectrum or a license shared frequency spectrum) in which an LBT scheme must be performed before transmitting.

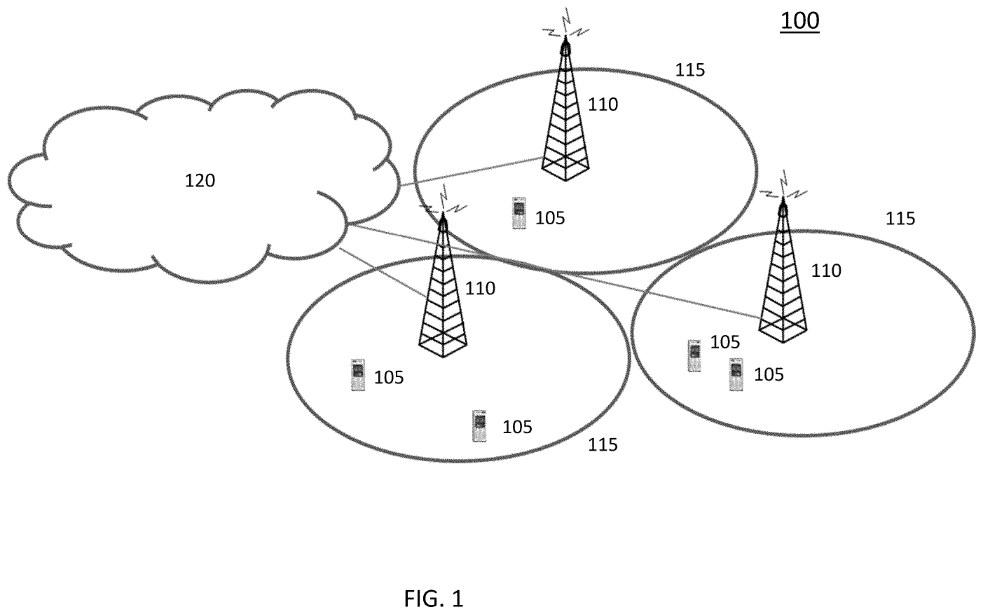

The described embodiments may be implemented in any appropriate type of communication system supporting any suitable communication standards and using any suitable components. For instance, although many example embodiments described herein are applicable for use with communication technologies that operate in unlicensed spectrum, where certain restrictions make sufficient coverage challenging, similar restrictions may exist in other contexts including, e.g., networks that operate using licensed spectrum, and embodiments of the invention are therefore applicable in a licensed spectrum context as well. As one example, certain embodiments may be implemented in an LTE network, such as that illustrated in FIG. 1.

Referring to FIG. 1, a communication network 100 comprises a plurality of wireless communication devices 105 (e.g., conventional UEs, machine type communication [MTC]/machine-to-machine [M2M] UEs) and a plurality of radio access nodes 110 (e.g., eNodeBs or other base stations). Communication network 100 is organized into cells 115, which are connected to a core network 120 via corresponding radio access nodes 110. Radio access nodes 110 are capable of communicating with wireless communication devices 105 along with any additional elements suitable to support communication between wireless communication devices or between a wireless communication device and another communication device (such as a landline telephone).

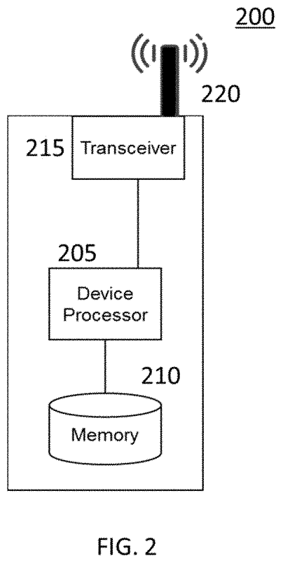

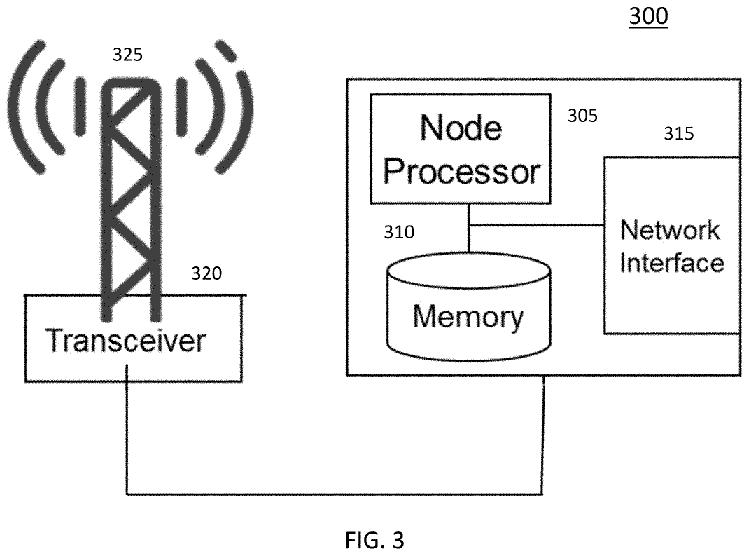

Although wireless communication devices 105 may represent communication devices that include any suitable combination of hardware and/or software, these wireless communication devices may, in certain embodiments, represent devices such as an example wireless communication device illustrated in greater detail by FIG. 2. Similarly, although the illustrated radio access node may represent network nodes that include any suitable combination of hardware and/or software, these nodes may, in particular embodiments, represent devices such as the example radio access node illustrated in greater detail by FIG. 3.

Referring to FIG. 2, a wireless device 200 comprises a processor 205, a memory, a transceiver 215, and an antenna 220. In certain embodiments, some or all of the functionality described as being provided by UEs, MTC or M2M devices, and/or any other types of wireless communication devices may be provided by the device processor executing instructions stored on a computer-readable medium, such as the memory shown in FIG. 2. Alternative embodiments may include additional components beyond those shown in FIG. 2 that may be responsible for providing certain aspects of the device's functionality, including any of the functionality described herein. As one example, additional antennas may be included to provide MIMO functionality for wireless device 200.

Referring to FIG. 3, a radio access node 300 comprises a node processor 305, a memory 310, a network interface 315, a transceiver 320, and an antenna 325. In certain embodiments, some or all of the functionality described as being provided by a base station, a node B, an enodeB, and/or any other type of network node may be provided by node processor 305 executing instructions stored on a computer-readable medium, such as memory 310 shown in FIG. 3. Alternative embodiments of radio access node 300 may comprise additional components to provide additional functionality, such as the functionality described herein and/or related supporting functionality.

In the embodiments describe herein, the wireless device 200 and radio access node 300 are operable to enhance coverage for control information on LBT cells in both the DL and UL. The enhanced coverage may be achieved according to one or more of various embodiments described hereafter, which can be categorized under the following subheadings:

“DL subframes with high cell reference symbol density”

“Coverage enhanced PDCCH”

“Coverage enhanced ePDCCH”

“Coverage enhanced UL Control Information”

These embodiments are described in the context of MF operation on 10 MHz and 20 MHz carriers in the 5 GHz unlicensed spectrum. However, the embodiments are generally applicable for coverage enhancement of any LTE-based or NR-based system operating in unlicensed spectrum.
DL Subframes with High Cell Reference Symbol Density

According to one embodiment, a radio access node 300 enhances the density of downlink reference signals on one or more ports. By increasing the RS density, CE wireless devices 200 can quickly determine the presence of a valid DL subframe without having to buffer, for example, 8 subframes (8 ms) of received samples. By reducing the number of buffer samples needed for accurate subframe detection, wireless device implementation costs and power consumption can be reduced correspondingly.

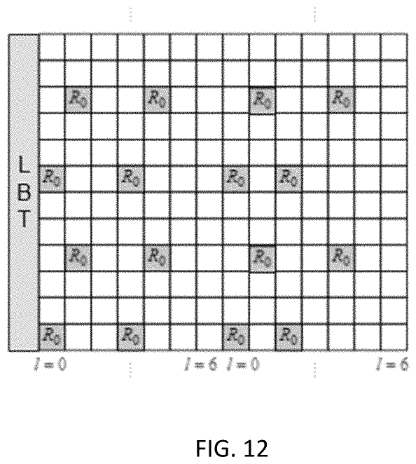

A non-limiting example of a high CRS density DL subframe format is shown in FIG. 12 for an arbitrary-labeled port ‘0’ in a DL subframe with normal CP. The DL LBT is assumed to be performed prior to the subframe boundary. In FIG. 12, the CRSs are allocated over four different OFDM symbol indexes of a slot, i.e., there are four symbols of CRS per slot, and the CRS time-domain locations for the single port ‘0’ reuse the existing values that are currently defined in LTE for multiple antenna ports and/or for normal and extended CP cases. Thus, compared to LTE, where the CRS density in the time domain is at most two CRS symbols per slot, the CRS density of the high CRS density DL subframe of FIG. 12 is doubled. In alternative embodiments, the exact positions of the CRSs shown in FIG. 12 may vary from that shown. For example, the CRS positions may be shifted such that the CRSs are allocated over only three different OFDM symbol indexes of a slot. Furthermore, the frequency-domain positions of the CRSs may be varied based on the specific antenna port, symbol index, and physical cell ID. Similar mappings can be defined for other antenna ports, where for other ports, the resource elements used for CRSs may not coincide with the ones used for port 0. In subframes with increased CRS density, PDSCH, PBCH, and (E)PDCCH resource element groups will not be mapped to resource elements used for CRS.

In certain embodiments, the CRS density may be increased in a partial DL TTI that spans less than 14 symbols. The partial DL TTI may occur at the beginning or end of a DL transmission burst. Moreover, in certain embodiments, dense-CRS DL subframes may be multiplexed in time with regular-CRS DL subframes on the same cell. Non-CE and CE wireless devices may be provided with higher-layer or dynamic signaling to indicate the presence or absence and CRS configuration of upcoming high CRS density subframes, in order to determine the appropriate resource element mappings of data and control channels. Furthermore, in certain embodiments DL DMRSs may be used at the same time together with increased CRS density, as described above, to further improve channel estimation and eliminate empty symbols in the DL subframe.

### Coverage Enhanced PDCCH

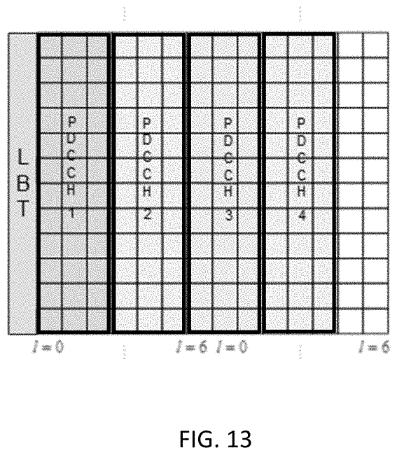

According to another embodiment, a PDCCH is repeated within a single subframe by allocating up to 14 symbols of the DL subframe for PDCCH transmission. For example, as shown in FIG. 13, a single 3-symbol PDCCH is transmitted four times (with the same aggregation level per PDCCH) within the same DL subframe by using a total of 12 OFDM symbols. This is advantageous compared to retaining the legacy solution of a 3-symbol PDCCH region that is repeated across four different DL subframes because the CE wireless devices may detect control information, such as a DL/UL grant or common control information, by processing only a single subframe, as opposed to buffering and processing four DL subframes. Moreover, non-CE wireless devices may still read the first PDCCH in the legacy control region to find common control information or UL/cross-carrier grants, among other things.

The number of PDCCH repetitions per subframe may be configured by higher layers, and may be or indicated via enhanced enhancement to the PCFICH. For instance, current LTE technical specifications only allow values 1, 2 or 3 to be carried by the PCFICH. The unused value of 4 may be used to indicate the coverage enhanced control channel design described herein.

For the wireless device processing of the PDCCH CE, the existing PDCCH search space mapping is time-shifted across the extended PDCCH CE region. The wireless device can subsequently decode each PDCCH repetition, then soft-combine the per-PDCCH decoder outputs across the subframe.

In certain embodiments, different aggregation levels may be used by one or more of the additional PDCCHs, where the highest PDCCH CE aggregation level may be increased to 16 or greater. This can be used to occupy all 14 symbols of the DL subframe, if so desired, at the cost of increased blind decoding complexity at the wireless device. Moreover, the expanded PDCCH region may be multiplexed with PHICH and PCFICH repetitions, to provide CE for PHICH and PCFICH.

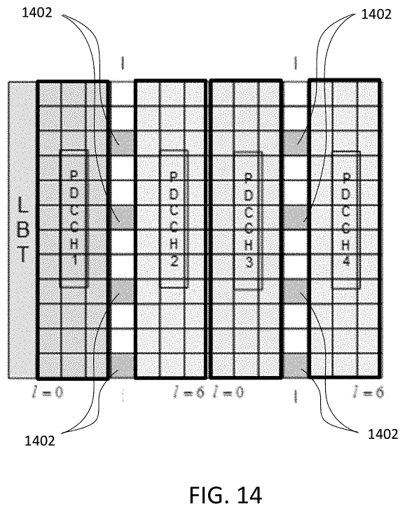

In certain embodiments, each PDCCH region occupies three OFDM symbols and at least one PDCCH region is offset from a subsequent PDCCH region by at least one OFDM symbol. Such an embodiment may be used where, for example, the cell-specific reference symbols (CRS) for port 0 and 1 are located in OFDM symbol index numbers 0, 4, 7 and 11. To maintain an identical location for CRSs in each PDCCH region (and thereby simplify implementation), the PDCCH regions may occupy OFDM symbol index numbers 0-2, 4-6, 7-9, and 11-13, as shown in FIG. 14. Moreover, additional reference symbols (1402) may be inserted in OFDM symbol index numbers 3 and 10 to enable enhanced channel estimation.

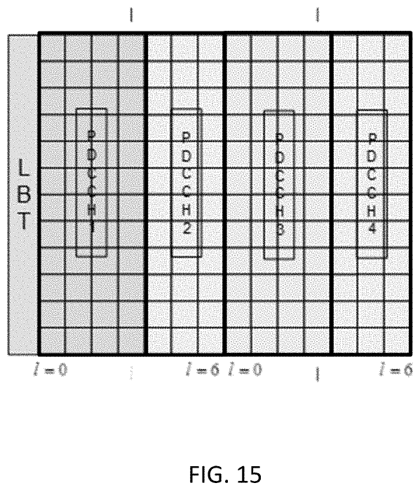

Current LTE technical specifications do not allow using four OFDM symbols for the control region if the system bandwidth is more than 1.4 MHz. However, in certain embodiments, the first PDCCH region uses four OFDM symbols, even though the system bandwidth is more than 1.4 MHz, but the second PDCCH region uses three OFDM symbols. These two PDCCH regions occupy the first slot as illustrated in FIG. 15. Moreover, in certain embodiments, these two PDCCH regions may be further repeated in a second slot immediately after the first slot.

### Coverage Enhanced EPDCCH

According to another embodiment, an EPDCCH, which is transmitted in the PDSCH region, may be repeated in the frequency domain within a single DL subframe to provide CE. Currently, an LTE wireless device can be configured with one or two EPDCCH PRB sets via higher-layer signaling. The legacy p^{th} PRB set for subframe k comprises a set of enhanced control channel elements (ECCEs) numbered from 0 to N_{ECCE,p,k}−1.

For the CE scenario, as a non-limiting example, each configured EPDCCH PRB set comprises a set of ECCEs numbered from 0 to T×N_{ECCE,p,k}−1, where T is the desired repetition factor used for CE. In certain embodiments, the highest allowed aggregation level for EPDCCH may also be increased. For example, the set of allowed EPDCCH aggregation levels for CE wireless devices is L′∈{1,2,4,8,16,32,64,128}.

### Coverage Enhanced UL Control Information

According to another embodiment, feedback redundancy may be utilized for control information such as CSI (e.g., CQI/PMI/PTI/RI) feedback and/or scheduling requests. For example, if a wireless device is scheduled for PUSCH CE transmission with an UL grant and one or more of the scheduled subframes coincides with a periodic CSI feedback occasion, then the CSI is multiplexed with PUSCH on all UL subframes of the scheduled UL burst. The same principle can be employed for autonomous, grant-less PUSCH CE transmissions. Furthermore, to enhance coverage for scheduling requests (SRs), the configuration of valid SR transmission occasions may be enhanced to also specify a repetition factor for SR transmissions, after any applicable UL LBT.

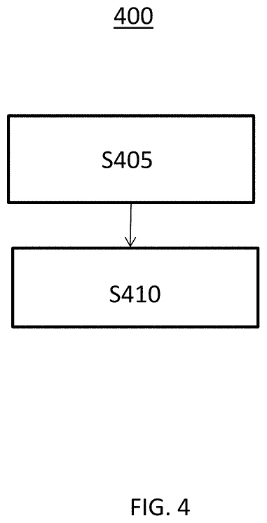

FIG. 4 is a flowchart illustrating a method of operating a wireless device 105 in unlicensed spectrum to facilitate coverage enhanced UL control information. In step S405, the wireless device 105 formats an OFDM transmission scheme UL subframe as a coverage enhanced (CE) UL subframe. The wireless device 105 may do so by repeating control information at least once in the CE UL subframe. Then, in step S410, the wireless device 105 transmits the CE UL subframe, using an unlicensed portion of spectrum, to a radio access node. As discussed herein, in some embodiments the control information may include CSI (e.g., CQI/PMI/PTI/RI) feedback and/or scheduling requests.

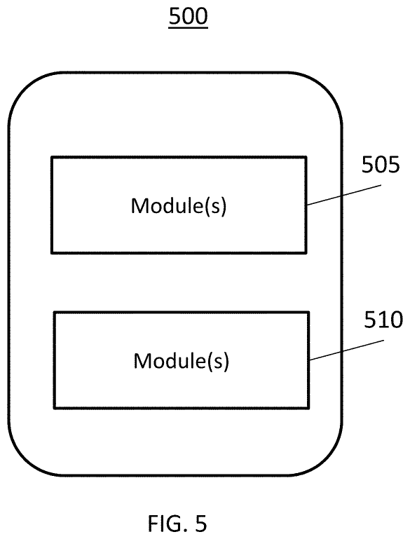

FIG. 5 is a block diagram illustrating a wireless device 500 according to some other embodiments of the present disclosure. The wireless device 500 includes one or more modules 505, each of which is implemented in software. The module(s) 505 provide the functionality of the wireless device 500 described herein.

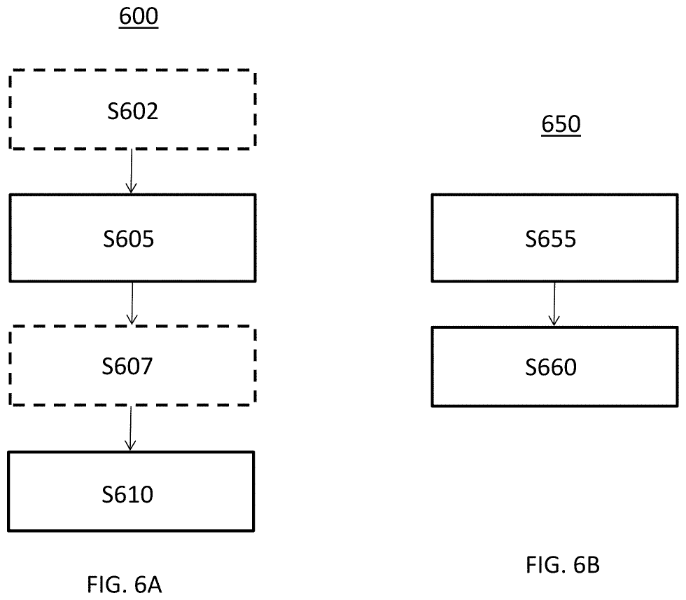

FIG. 6A is a flowchart illustrating a method 600 of operating a radio access node 110 in unlicensed spectrum to facilitate transmission of coverage enhanced DL control channels. In step S605, the radio access node 110 formats a slot of an OFDM transmission scheme DL subframe with a high density of cell reference symbols (CRS). The radio access node 110 may do so by allocating CRSs over at least three different OFDM symbol index numbers of the slot. For example, in one embodiment, the CRSs are allocated over four different OFDM symbol index numbers of the slot. In certain embodiments, the dense-CRS DL subframes may be multiplexed in time with regular-CRS DL subframes on the same cell at step S607. Then, in step S610, the radio access node 110 transmits the high CRS density DL subframe (or the multiplexed subframes if the multiplexing stem S607 is performed), using an unlicensed portion of spectrum, to one or more wireless devices 105. In an optional step S602, preceding or coincident with step S605, the radio access node 110 signals to one or more wireless devices, in advance of transmitting a high CRS density DL subframe, the presence of the high CRS density DL subframe.

As discussed herein, in some embodiments, the slot may be further formatted by the radio access node 110 to contain at least a portion of a PDSCH, a PBCH, or a PDCCH. In other embodiments, as discussed herein, the high CRS density DL subframe is multiplexed in time with a regular DL subframe, i.e., a DL subframe having low CRS density, in which cell reference symbols are allocated over less than three different OFDM symbol index numbers of a slot. The multiplexed subframes may then be transmitted, using unlicensed spectrum, to the one or more wireless devices 105. Further still, in certain embodiments, the radio access node 110 signals to the one or more wireless devices 105, in advance of transmitting the high CRS density DL subframe, the presence of the high CRS density DL subframe.

FIG. 6B is a flowchart illustrating another method 650 of operating a radio access node 110 in unlicensed spectrum to facilitate transmission of coverage enhanced DL control channels. The method 650 may be performed together with or independent of the method 600. In step S655, the radio access node 110 formats an OFDM transmission scheme DL subframe as a coverage enhanced (CE) DL subframe. The radio access node 110 may do so by repeating a control channel at least once in the CE DL subframe. Then, in step S660, the radio access node 110 may transmit the CE DL subframe to one or more wireless devices 105. In one embodiment the transmission is made using an unlicensed portion of spectrum.

As discussed herein, in some embodiments, the control channel includes a PDCCH. Moreover, the control channel may further include a repetition of at least one of a PHICH and a PCFICH multiplexed with the repeated PDCCH. Furthermore, in other embodiments disclosed herein the control channel includes an EPDCCH that is repeated at least once in the frequency domain. Further still, in some embodiments the DL subframe is formatted such that a first control channel region for a first instance of the control channel is offset from a subsequent control channel region for a second instance of the control channel by at least one OFDM symbol.

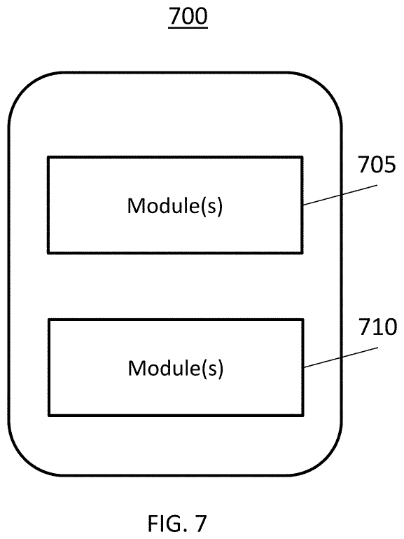

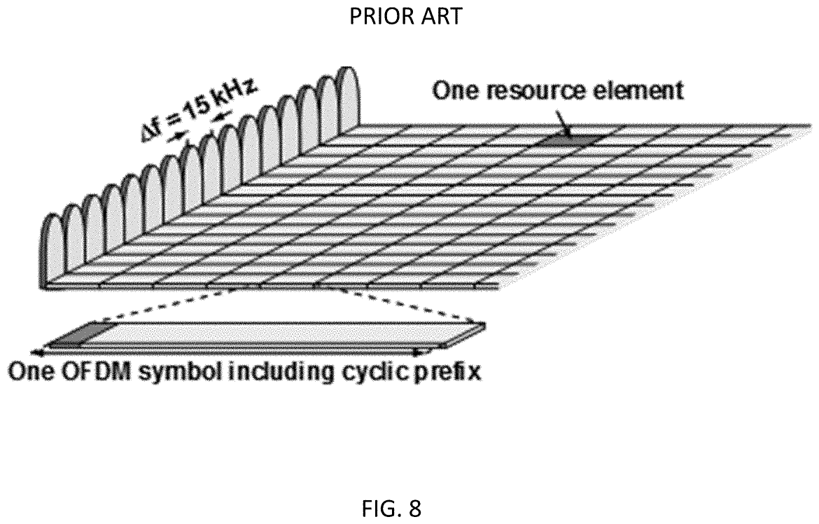

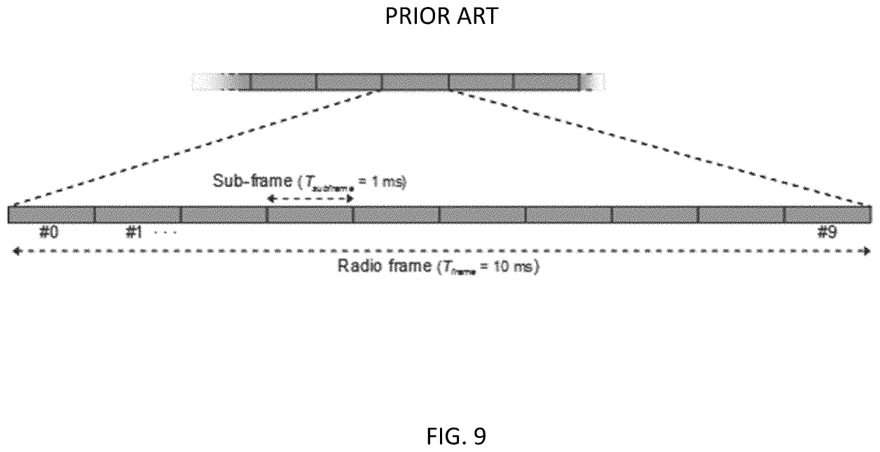

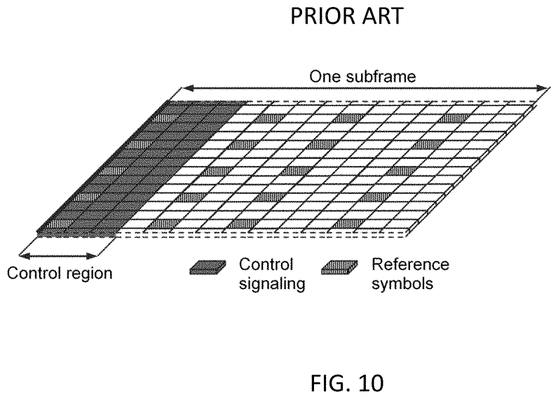

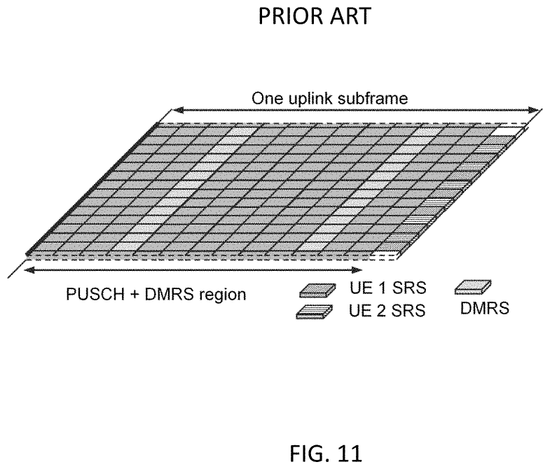

FIG. 7 is a block diagram illustrating a radio access node 700 according to some other embodiments of the present disclosure. The radio access node 700 includes one or more modules 705, each of which is implemented in software. The module(s) 705 provide the functionality of the radio access node 700 described herein.

As described above, the exemplary embodiments provide both a method and corresponding apparatus consisting of various modules providing functionality for performing the steps of the method. The modules may be implemented as hardware (embodied in one or more chips including an integrated circuit such as an application specific integrated circuit), or may be implemented as software or firmware for execution by a processor. In particular, in the case of firmware or software, the exemplary embodiments can be provided as a computer program product including a computer readable storage medium embodying computer program code (i.e., software or firmware) thereon for execution by the computer processor. The computer readable storage medium may be non-transitory (e.g., magnetic disks; optical disks; read only memory; flash memory devices; phase-change memory) or transitory (e.g., electrical, optical, acoustical or other forms of propagated signals-such as carrier waves, infrared signals, digital signals, etc.). The coupling of a processor and other components is typically through one or more busses or bridges (also termed bus controllers). The storage device and signals carrying digital traffic respectively represent one or more non-transitory or transitory computer readable storage medium. Thus, the storage device of a given electronic device typically stores code and/or data for execution on the set of one or more processors of that electronic device such as a controller.

Although the embodiments and its advantages have been described in detail, it should be understood that various changes, substitutions, and alterations can be made herein without departing from the spirit and scope thereof as defined by the appended claims. For example, many of the features and functions discussed above can be implemented in software, hardware, or firmware, or a combination thereof. Also, many of the features, functions, and steps of operating the same may be reordered, omitted, added, etc., and still fall within the broad scope of the various embodiments.

Moreover, the scope of the various embodiments is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed, that perform substantially the same function or achieve substantially the same result as the corresponding embodiments described herein may be utilized as well. Accordingly, the appended claims are intended to include within their scope such processes, machines, manufacture, compositions of matter, means, methods, or steps.

The following acronyms are used throughout this disclosure.

| | |
|---|---|
| CE | Coverage Enhancement |
| CP | Cyclic Prefix |
| CRS | Cell-specific Reference Symbol |
| IFDMA | Interleaved Frequency Division Multiple Access |
| PBCH | Physical Broadcast Channel |
| PDSCH | Physical Downlink Shared Channel |
| PCFICH | Physical Control Format Indicator Channel |
| PCID | Physical Cell Identity |
| PRB | Physical Resource Block |
| IoT | Internet of Things |
| LBT | Listen Before Talk |
| MCOT | Maximum Channel Occupancy Time |
| MTC | Machine-type communication |
| MF | MulteFire |
| NB-IoT | Narrow-band Internet of Things |
| NB-IoT-U | Narrow-band Internet of Things for Unlicensed Band |
| UE | User equipment |
| eNB | Evolved Node B |
| ePUCCH | enhanced Physical Uplink Control Channel |
| sPRACH | shortened Physical Random Access Channel |
| LBT | Listen Before Talk |
| PSD | Power Spectral Density |
| TTI | Transmission Time Interval |
| TXOP | Transmission Opportunity |
| UL | Uplink |
| DL | Downlink |

Those skilled in the art will recognize improvements and modifications to the embodiments of the present disclosure. All such improvements and modifications are considered within the scope of the concepts disclosed herein.

1-6. (canceled)

7. A method for improving a control channel coverage in a radio access node operable for use in a cellular communications network, the method comprising:
formatting an OFDM transmission scheme DL subframe as a coverage enhanced (CE) DL subframe by repeating a control channel at least once in the CE DL subframe; and
transmitting the CE DL subframe to one or more wireless devices.

8. The method of claim 7, wherein the control channel includes a PDCCH.

9. The method of claim 8, wherein the control channel further includes a repetition of at least one of a PHICH and a PCFICH multiplexed with the repeated PDCCH.

10. The method of claim 7, wherein the control channel includes an EPDCCH that is repeated at least once in the frequency domain.

11. The method of claim 7, wherein the DL subframe is formatted such that a first control channel region for a first instance of the control channel is offset from a subsequent control channel region for a second instance of the control channel by at least one OFDM symbol.

12. The method of claim 11, wherein the CE DL subframe is formatted such that the repeated control channels occupy OFDM symbols that differ from the OFDM symbols occupied by reference symbols in a non-CE DL subframe.

13. The method of claim 7, wherein the CE DL subframe is transmitted using an unlicensed portion of spectrum.

14. A method for improving transmission of control information in a wireless device operable for use in a cellular communications network, the method comprising:
formatting an OFDM transmission scheme UL subframe as a coverage enhanced (CE) UL subframe by repeating control information at least once in the CE UL subframe; and
transmitting the CE UL subframe to a radio access node.

15-20. (canceled)

21. A radio access node configured for use in a cellular communications network, the radio access node comprising:
processing circuitry and a memory, the memory containing instructions executable by the processing circuitry whereby the radio access node is configured to:
format an OFDM transmission scheme DL subframe as a coverage enhanced (CE) DL subframe by repeating a control channel at least once in the CE DL subframe; and
transmit the CE DL subframe to one or more wireless devices.

22. A wireless device configured for use in a cellular communications network, the wireless device comprising:
processing circuitry and a memory, the memory containing instructions executable by the processing circuitry whereby the wireless device is configured to:
format an OFDM transmission scheme UL subframe as a coverage enhanced (CE) UL subframe by repeating control information at least once in the CE UL subframe; and
transmit the CE UL subframe to a radio access node.

23-30. (canceled)

31. The radio access node of claim 21, wherein the CE DL subframe is transmitted using an unlicensed portion of spectrum.

32. The radio access node of claim 21, wherein the DL subframe is formatted such that a first control channel region for a first instance of the control channel is offset from a subsequent control channel region for a second instance of the control channel by at least one OFDM symbol.

33. The wireless device of claim 22, wherein the CE UL subframe is transmitted using an unlicensed portion of spectrum.
